(19) United States
(12) Patent Application Publication
(10) Pub. No.: US 2025/0044423 A1
(43) Pub. Date: Feb. 6, 2025

(54) ELECTRONIC DEVICE, METHOD AND COMPUTER PROGRAM

(71) Applicant: Sony Semiconductor Solutions Corporation, Atsugi-shi, Kanagawa (JP)

(72) Inventors: Victor BELOKONSKIY, Stuttgart (DE); Ruxandra Marina FLOREA, Stuttgart (DE)

(73) Assignee: Sony Semiconductor Solutions Corporation, Atsugi-shi, Kanagawa (JP)

(21) Appl. No.: 18/717,449

(22) PCT Filed: Dec. 13, 2022
(86) PCT No.: PCT/EP2022/085680

§ 371 Date: Jun. 7, 2024

(30) Foreign Application Priority Data
Dec. 17, 2021 (EP) 21215576.6

(51) Int. Cl. G01S 7/4863; G01S 17/10; G01S 17/894

(52) U.S. Cl. CPC G01S 7/4863; G01S 17/10; G01S 17/894

(57) ABSTRACT

An electronic device which comprises circuitry configured to set, for sub-integration cycles within an integration cycle of a pixel of a time-of-flight imaging sensor, a non-constant length of an overflow gate time during which an overflow gate of the pixel is active.

### TECHNICAL FIELD

The present disclosure generally pertains to the field of Time-of-Flight imaging, and in particular to devices, methods and computer program for Time-of-Flight image capturing.

### TECHNICAL BACKGROUND

A Time-of-Flight (ToF) camera is a range imaging camera system that determines the distance of objects by measuring the time of flight of a light signal between the camera and the object for each point of the image. Generally, a Time-of-Flight camera has an illumination unit that illuminates a region of interest with modulated light, and a pixel array that collects light reflected from the same region of interest.

In direct Time-of-Flight (dToF), the distance can be determined, for example, based on the time-of-flight of the photons of the light source reflected in the region of interest, which, in turn, is associated with the distance, and it can be based, for example, on a direct trip time of the light when travelling from the light source to the sensor.

In indirect Time-of-Flight (iToF), three-dimensional (3D) images of a scene are captured by an iToF camera, which is also commonly referred to as “depth map”, or “depth image” wherein each pixel of the iToF image is attributed with a respective depth measurement. The depth image can be determined directly from a phase image, which is the collection of all phase delays determined in the pixels of the iToF camera.

Although there exist techniques for determining distance or depth measurements with a ToF camera, it is generally desirable to provide techniques which improve the determining of distance or depth measurements with a ToF camera.

### SUMMARY

According to a first aspect, the disclosure provides an electronic device comprising circuitry configured to set, for sub-integration cycles within an integration cycle of a pixel of a time-of-flight imaging sensor, a non-constant length of an overflow gate time during which an overflow gate of the pixel is active.

According to a second aspect, the disclosure provides a method comprising setting, for sub-integration cycles within an integration cycle of a pixel of a time-of-flight imaging sensor, a non-constant length of an overflow gate time during which an overflow gate of the pixel is active.

According to a third aspect, the disclosure provides a computer program comprising instructions which, when the program is executed by a computer, cause the computer to set, for sub-integration cycles within an integration cycle of a pixel of a time-of-flight imaging sensor, a non-constant length of an overflow gate time during which an overflow gate of the pixel is active.

Further aspects are set forth in the dependent claims, the following description, and the drawings.

### BRIEF DESCRIPTION OF THE DRAWINGS

Embodiments are explained by way of example with respect to the accompanying drawings, in which:

FIG. 1 schematically shows an embodiment of an indirect Time-of-Flight imaging system having multiple iTof cameras in a multi-camera scenario, wherein two indirect time-of-flight cameras illuminate the same scene simultaneously;

FIG. 2 schematically shows the operational principle of an indirect Time-of-Flight imaging device, such as the iToF cameras of FIG. 1, which can be used for depth sensing or providing a distance measurement;

FIG. 3 schematically shows an embodiment of a frame structure of a 7-tap iToF pixel;

FIG. 4 schematically illustrates a timing diagram of illumination and reflection signals in a multi-camera scenario;

FIG. 5 schematically shows a timing diagram for a sub-integration cycle of an iToF pixel with seven taps in a multi-camera scenario, wherein the overflow gate OFG time is constant;

FIG. 6 schematically shows a timing diagram for a sub-integration cycle of an iToF pixel with seven taps in a multi-camera scenario, wherein the overflow gate OFG time is random;

FIG. 7 schematically shows an embodiment of an electronic system including an electronic device that reduces multi-camera interference occurrence in a multi-camera scenario; and

FIG. 8 shows a flow diagram visualizing a method for a multi-camera operation in an N-tap system for reducing multi-camera interference.

### DETAILED DESCRIPTION OF EMBODIMENTS

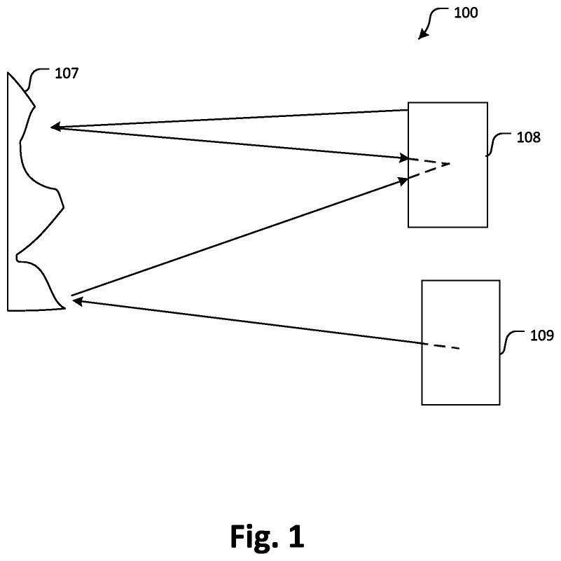

Before a detailed description of the embodiments is given under reference of FIGS. 1 to 8, some general explanations are made.

As indicated in the outset, typically, a Time-of-Flight (ToF) camera is a range imaging camera system that determines the distance of objects by measuring the time of flight of a light signal between the camera and the object for each point of the image. Acquisitions of the light signal at short distances are typically covered by indirect Time of Flight (iToF) systems and the acquisitions at mid-to-long distances are typically covered by direct Time of Flight (dToF) systems.

In indirect Time-of-Flight (iToF), three-dimensional (3D) images of a scene are captured by an iToF camera, wherein each pixel of the iToF image is attributed with a respective depth measurement. The depth image can be determined directly from a phase image, which is the collection of all phase delays determined in the pixels of the iToF camera.

Current ToF systems e.g. comprise image sensors with pixels of the so called “2-tap” type, which allow for a VGA resolution or higher and ensure accuracy in the millimeter range at object distances below 1 meter. Moreover, scattering effects from highly reflective objects at close distances may make long-range objects difficult to detect. Furthermore, temporal accumulation (i.e., microframe-based acquisition) may make the ToF system prone to artefacts due to motion of objects spanning multiple microframes.

Generally, it may happen that multiple time-of-flight cameras illuminate the same region of interest, such that the measurements may cause interferences.

It is known, that ToF systems comprising more than two taps, namely N-tap systems, have significantly shorter integration time than conventional ToF systems as well as range-locked signal accumulation. This may make them more robust to multicamera interference compared to conventional ToF system.

However, there may still be an impact of interference in the case of synchronous interference signals. Synchronous interference signals may for example happen if the same camera type, and/or similar camera modes are involved. In this case, more information related to the interference signal may be acquired. As all tap values are used in the datapath, i.e., during the Fast Fourier Transform stage, the interference signal may have a higher impact on the depth reconstruction. Even with background suppression techniques, the residual in the “interference” taps may be significantly higher than in the ambient light-only taps (so-called “empty” taps) and may act as an extra source of noise.

During the sub-integration time, taps are sequentially activated, and they collect photo-electrons during the “active” time. After this “active” time, the overflow, OFG, is activated and all remaining/incoming photo-electrons are drained out. This phase is also called “inactive” time.

It has been recognized that at least one or more of the issues mentioned above, may be addressed by controlling the “inactive” time within the sub-integration time. Thereby, also scattering, and multipath may be mitigated.

The embodiments described below in more detail describe an electronic device comprising circuitry configured to set, for sub-integration cycles within an integration cycle of a pixel of a time-of-flight imaging sensor, a non-constant length of an overflow gate time during which an overflow gate of the pixel is active.

The electronic device may for example be a time-of-flight camera comprising an imaging sensor, without limiting the present disclosure in that regard. Alternatively, the electronic device may for example be an imaging sensor of an imaging camera, in particular a sensor of a ToF camera. For example, the electronic device may be an imaging sensor with N-tap pixels, where N denotes the number of taps provided in a pixel of the imaging sensor. Here, a tap may be any structure or configuration of a pixel of a camera sensor used to output data.

The electronic device may also comprise additional circuitry. For example, circuitry of the electronic device may include electronic components such as switching elements (gates, transistors, etc.), resistors, memory elements (capacitors, RAM, ROM or the like), pixel circuitry, a storage, input means (mouse, keyboard, camera, etc.), output means (display (e.g., liquid crystal, (organic) light emitting diode, etc.), loudspeakers, etc., a (wireless) interface, etc., as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g., radar, humidity, light, temperature), etc.

A pixel may be any single cell of an image sensor. When light is captured by an image sensor, a photo sensor (e.g., a photodiode) in each pixel produces an electrical charge (photoelectrons). The electrical charges (photoelectrons) accumulated in the pixels of an image sensor may be transferred by read-out electronics from the pixels to a processer for post-processing of an image. The pixel may be an N-tap pixel, wherein N may be equal to or larger than two (N≥2). For example, the pixel may be a 7-tap pixel having 0-6 transfer gates and an overflow gate, OFG.

An integration cycle may be a time (period of time) during which a sequence of light pulses is emitted by the illumination unit of a ToF imaging device, for example, by the electronic device. The integration cycle may comprise one sub-integration cycle, without limiting the present disclosure in that regard. Alternatively, the integration cycle may comprise more than one sub-integration cycles.

A sub-integration cycle may comprise a time (period of time) during which an overflow gate, OFG, of the pixel of the ToF device, is active and a period of time during which transfer gates of the pixel are active. One sub-integration cycle may be defined as lasting from the beginning of the activation of the first transfer gate of the pixel (N-tap pixel), corresponding to a respective tap, until the deactivation of the overflow gate OFG.

For example, the integration cycle may comprise a plurality of sub-integration cycles and the respective overflow gate times for the plurality of sub-integration cycles within the integration cycle may vary.

An overflow gate time may describe the time (or period of time) in which the overflow gate is active. For example, the overflow gate time may be an “inactive time”, and the time during which transfer gates of the pixel are activated may be an “active time”.

An overflow gate may be implemented e.g. as one or more transistors. The overflow gate OFG may accumulate and collect (drain) all remaining and unnecessary photoelectrons generated due to received light by the pixel outside the time period where all transfer gates are closed. The overflow gate may be activated the remaining time of the sub-integration cycle, after the time period where all transfer gates are closed.

By randomly setting a length of the overflow gate time, the ToF device may obtain improved distance or depth measurements. For example, in a multicamera scenario, the ToF device may obtain distance or depth measurements with a significantly reduced interference signal. The interference signal may be a signal which comprises a reflected signal of a primary ToF camera and a reflected signal of a secondary ToF camera in the multicamera scenario. The interference signal may act as an additional source of noise, other than the ambient light detected while the primary ToF camera performs distance or depth measurements.

In some embodiments, the circuitry may be configured to randomly set for a sub-integration cycle within the integration cycle the length of the overflow gate time.

In some embodiments, the circuitry may be configured to activate the overflow gate within the sub-integration cycle. During the time which the overflow gate is active, all unwanted photoelectrons are drained by the overflow gate OFG. The overflow gate may be activated the remaining time of the sub-integration cycle, after the time period where all transfer gates of the pixel are closed.

In some embodiments, the circuitry may be configured to activate transfer gates of the pixel within the sub-integration cycle one after the other for a predetermined time according to a predetermined pulse width equal to a pulse width of a light pulse of a light pulse sequence produced by an illumination unit of the time-of-flight imaging sensor.

For example, the circuitry may comprise transfer gates each corresponding to a respective tap of the pixel, e.g., of an N-tap pixel, and the overflow gate. During the integration cycle a sequence of light pulses are emitted by the illumination unit of the ToF imaging device. A transfer gate may for example be implemented as a transistor. However, other switching elements may be used as an alternative to transistors.

The circuitry may be configured to activate the transfer gates according to a predetermined pulse width which is equal to the pulse width of pulses of a light pulse sequence, without limiting the present disclosure in that regard. Alternatively, the illumination pulse width may be wider or narrower than predetermined pulse width opening the transfer gates.

The circuitry may be configured to generate a light pulse sequence which has a duty cycle equal or lower than 1%. The sub-integration cycle may have a time span which may be equal to the period of one emitted light pulse (although the pulse width is only 1% of the pulse period).

In some embodiments, the circuitry may be configured to activate the overflow gate after the end of the predetermined time within which the transfer gates have been activated.

In some embodiments, the sub-integration cycle may be defined by each pulse of the light pulse sequence produced by the illumination unit of the time-of-flight imaging sensor.

In some embodiments, the integration cycle may comprise a plurality of sub-integration cycles and may be defined by the light pulse sequence produced by the illumination unit of the time-of-flight imaging sensor.

In some embodiments, reflected light of each pulse of the light pulse sequence may be captured by the transfer gates based on photo-electron collection within the sub-integration cycle. The active pulses may be reflected from objects within a scene illuminated by the illumination unit of the time-of-flight imaging sensor and the reflected light may be captured by the time-of-flight imaging sensor based on photo-electron collection by the transfer gates of the pixel each corresponding to a respective tap. For example, in a multicamera scenario, the transfer gates may collect photons from reflected light of a secondary camera, thus interference signal may be generated.

In some embodiments, in at least two sub-integration cycles within the integration cycle, the reflected light of each pulse may be capture by different transfer gates of the pixel. In a multicamera scenario, the interference signal may be capture by different transfer gates within the integration cycle, that is, the interference signal may be spread over different taps of the pixel each tap corresponding to a respective transfer gate.

In some embodiments, the circuitry may be configured to set a starting point of the overflow gate time in which the overflow gate is activated within the sub-integration cycle.

In some embodiments, each of plurality of sub-integration cycles within the integration cycle may be constant. In other words, changing the length of the overflow gate time may not affect the duration of the sub-integration cycle.

In some embodiments, the length of the overflow gate time may be set by applying a random variation on the overflow gate time. Applying random variation in the “inactive” time of the pixel, e.g., of an N-tap pixel, this may imply activating the overflow gate for a (pseudo-) random time. In this manner, the random variation may reduce the interference signal and thus distance or depth measurements may be improved.

In some embodiments, the length of the overflow gate time may be randomly set based on a binary sequence.

In some embodiments, the binary sequence may be a pseudorandom binary sequence (PRBS).

In some embodiments, the length of the overflow gate time may be set based on a variable-length code. A variable-length code respecting the prefix condition may be used to set the length of the overflow gate time. This may improve the detectability of the method, above that brought by a nonuniform overflow gat time.

In some embodiments, the length of the overflow gate time may be set based on a different-length code. The different-length code may be used for the overflow gate time of different ToF cameras. This may help to identify the different origin of the interference signal.

In some embodiments, the time-of-flight imaging sensor may be part of a primary time-of-flight camera in a multicamera scenario.

In some embodiments, the multicamera scenario may comprise at least one secondary time-of-flight camera.

In some embodiments, the primary time-of-flight camera and the secondary time-of-flight camera may be of the iToF type or dtoF type.

The embodiments also disclose a method comprising randomly setting, for a sub-integration cycle within an integration cycle of a pixel of a time-of-flight imaging sensor, a length of an overflow gate time during which an overflow gate of the pixel is active.

The embodiments also disclose a computer program comprising instructions which, when the program is executed by a computer, cause the computer to randomly set, for a sub-integration cycle within an integration cycle of a pixel of a time-of-flight imaging sensor, a length of an overflow gate time during which an overflow gate of the pixel is active.

Embodiments are now described by reference to the drawings.

Multi-Camera Scenario in an Indirect Time-of-Flight Imaging System (iToF)

FIG. 1 schematically shows an embodiment of an indirect Time-of-Flight imaging system having multiple iTof cameras in a multi-camera scenario, wherein two indirect time-of-flight cameras illuminate the same scene simultaneously.

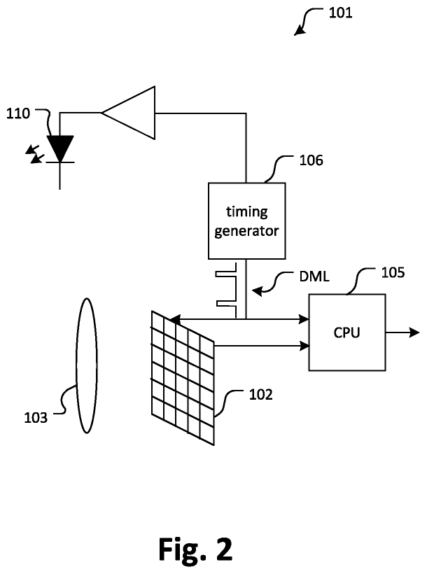

The indirect Time-of-Flight imaging system 100 includes two iToF cameras 108 and 109 having the same camera type and operate in a similar mode. iToF camera 108 illuminates the scene 107 with amplitude-modulated infrared light at a predetermined wavelength using its illumination unit (see 110 in FIG. 2). The amplitude-modulated infrared light is reflected from objects within the scene 107. The reflected light is collected by iToF camera 108 and a depth image is generated. Similarly, secondary iToF camera 109 illuminates the scene 107 with amplitude-modulated infrared light at a predetermined wavelength. The amplitude-modulated infrared light is reflected from the objects within the scene 107. A part of the reflected light related to iToF camera 109 is collected by iToF camera 108. Therefore, an interference signal, e.g., a synchronous interference signal, is acquired by iToF camera 108. In this way, a multi-camera interference occurs. The interference signal acts as an additional source of noise, other than ambient light.

It should be noted that multi-camera interference may occur not only in an iToF multi-camera scenario but also in a direct ToF (dToF) multi-camera scenario. In a case where multiple time-of-flight cameras illuminate the same region of interest for performing distance or depth measurements, the measurements may cause interferences.

Operational Principle of an Indirect Time-of-Flight Imaging Device (iToF)

FIG. 2 schematically shows the operational principle of an indirect Time-of-Flight imaging device, such as the iToF cameras of FIG. 1, which can be used for depth sensing or providing a distance measurement. The iToF imaging device 101 is implemented as the first and second iToF cameras described with regard to FIG. 1 above. The iToF imaging device 101 includes an imaging sensor 102 and a processor (CPU) 105. An illumination unit 110 actively illuminates a scene (see 107 in FIG. 1) with amplitude-modulated infrared light, LMS, at a predetermined wavelength, for instance with some light pulses of at least one predetermined modulation frequency, DML, generated by a timing generator 106. The amplitude-modulated infrared light is reflected from objects within the scene. A lens 103 collects the reflected light, RL, and forms an image of the objects onto the imaging sensor 102, having a matrix of pixels, of the iToF imaging device 101. In indirect Time-of-Flight (iToF) the CPU 105 correlates the reflected light, RL, with the modulation signal, DML, which yields an inphase component value (“I value”) for each pixel and quadrature component values (“Q-value”) for each pixel, so called I and Q values. Based on the I and Q values for each pixel a phase delay value may be calculated for each pixel which yields a phase image. Based on the phase image a depth value may be determined for each pixel which yields the depth image. Still further, based on the I and Q values, an amplitude value and a confidence value may be determined for each pixel which yields the amplitude image and the confidence image.

iToF measurements provide N differential mode measurements, i.e., N different measurements collected at the N taps (tap information). The tap information is considered as component information, i.e., samples of the correlation waveform between the reference/emitted signal and the received signal. That is, obtaining depth information (as well as confidence and amplitude) is done in the Fourier domain.

An N-tap ToF pixel for example is a ToF pixel with more than two taps (N>2), for example N=7 taps, including an overflow gate, OFG, each tap related to a respective transfer gate.

### Frame Structure

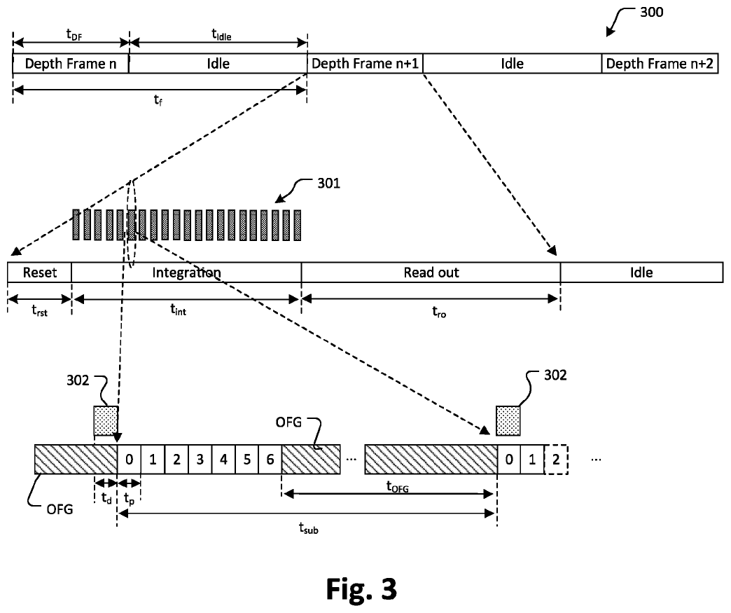

FIG. 3 schematically shows an embodiment of a frame structure of a 7-tap iToF pixel.

Signal 300 comprises an alternating structure of depth frames t_{DF} (depth frames n, n+1, n+2, . . . ) and idle periods t_{idle} at a frame rate of 30 frames per second (t_{f}=33.3 ms). A depth frame (here for example depth frame n+1) comprises a reset period, tᵣₛₜ, followed by an integration period, tᵢₙₜ, (integration cycle) again followed by a read-out period, tᵣₒ. During the integration period a sequence 301 of light pulses are emitted by the illumination unit of the iToF imaging device (see 110 in FIG. 2). The illumination period may for example last 400 μs and may comprise 800 pulses of 5 ns, which yields a duty cycle of 1%. The read-out period tᵣₒ may last 5.3 ms and the read-out may be performed MIPI standard compliant.

Each pulse 302 of the sequence 301 of light pulses defines a sub-integration cycle. Within a sub-integration cycle the first to the seventh transfer gates which correspond to taps 0 to 6 are active one after the other followed by an activation of the overflow gate OFG. One sub-integration cycle is defined as lasting from the beginning of the activation of the first transfer gate, corresponding to tap 0, until the deactivation of the overflow gate OFG. The sub-integration cycle has a time span t_{sub} which may be t_{sub}=500 ns, which equals the period of one emitted light pulse (although the pulse width is only 1% of the pulse period). The activation pulse width tₚ of the transfer gates may be equal and may for example be tₚ=5 ns. The pulse width of the emitted light may be equal or smaller than the activation pulse width tₚ of the transfer gates (pulse active time tₚ). The transfer gates may be activated directly each of the other, which yields a combined activation time of as tₘₐₓ=35 ns per sub-integration cycle. The overflow gate OFG may be activated the remaining time t_{OFG} of the sub-integration cycle t_{sub} which may be t_{OFG}=465 ns. The combined activation time tₘₐₓ of all transfer gates and corresponding taps defines the (radial) range in which the iToF camera can record objects. The emitted light pulse 302 may have a time delay t_{d} (phase shift) with respect to the activation of the first transfer gate, corresponding to tap 0. The time delay t_{d} may for example be t_{d}=1 ns. The number of sub-integration cycles per integration period (integration cycle) may be determined according to the SNR target.

During each sub-integration cycle of the integration cycle (see bottom part of FIG. 3), taps are sequentially activated and collect photo-electrons (“active” time), after which the OFG is activated and all remaining/incoming photo-electrons are drained out (“inactive” time). During the sub-integration time t_{sub}, taps are sequentially activated and collect photo-electrons, i.e. “active” time. Each transfer gate, and thus each tap, is activated one after the other for a predetermined activation time so as to collect incident photons, i.e., photo-electrons, of the reflected light. The activation of a next tap corresponds to an acquisition with a different phase shift applied on the reference/emitted signal (a train of pulses, a sinusoid, etc.).

After the activation of the transfer gates, the overflow gate OFG is activated and all remaining and incoming photo-electrons are drained out, i.e. “inactive” time. The overflow gate OFG is opened after the last transfer gate has been closed.

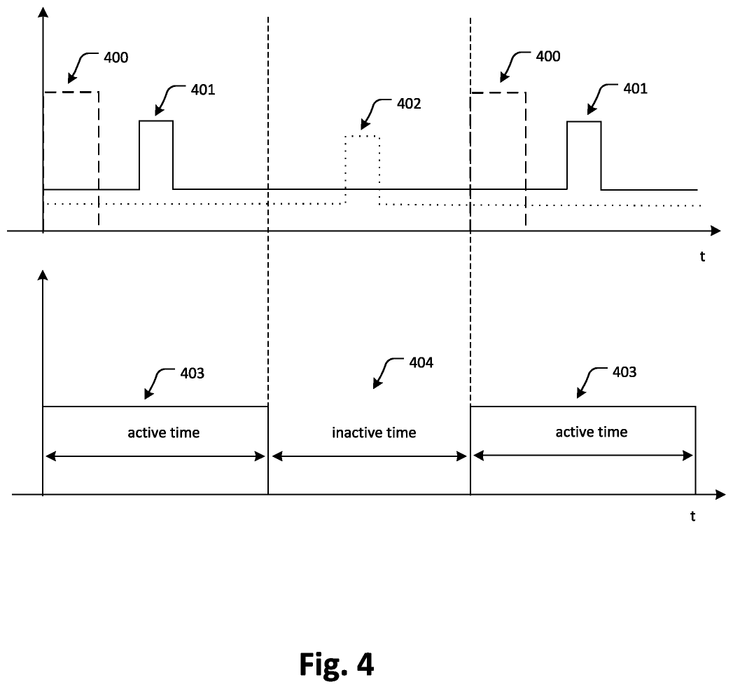

The “active” time and the “inactive” time is described in more detail in the embodiment with regard to FIG. 4 below. The sub-integration time t_{sub} is independent of the OFG time t_{OFG}. In other words, changing the length of the OFG time t_{OFG} will not impact the sub-integration time t_{sub}. Other than with previously known iToF pixels (for example a 2-tap pixel), in the case of the N-tap pixel a single integration period may be enough for full depth acquisition. Therefore, less or even no motion blurring (due to a movement of a recorded object during read-out periods) may occur, and the N-tap pixel is therefore natively motion robust.

The described process, which is called “sub-integration cycle” is repeated multiple times to achieve measurements over a predefined integration cycle.

It should be noted that FIG. 3 depicts a general (standard) frame structure covering multiple microframes and multiple phases. This embodiment relies on the concept of multiple taps, although it could be adapted to standard 2-tap or other depth sensing systems.

### Depiction of “Active” Time and “Inactive” Time

FIG. 4 schematically illustrates a timing diagram of illumination and reflection signals in a multi-camera scenario. The “active” time and “inactive” time during integration is also indicated.

In the upper part of FIG. 4, the dashed line represents the illumination signal 400 of a (primary) iToF camera (e.g. camera 108 of FIG. 1). The solid line represents the reflection illumination signal 401 captured by the primary iToF camera, the reflection illumination signal 401 relating to the illumination light that originates from the primary camera. The dotted line represents the reflection illumination signal 402 captured by the primary iToF camera, the reflection illumination signal 402 relating to the illumination light that originates from a secondary camera (e.g., camera 109 of FIG. 1).

The two vertical dashed lines separate the timing diagram in three different time periods, namely an “active” time 403 followed by an “inactive” time 404, followed again by an “active” time 403.

The “active” time of the iToF camera covers the active light pulse being emitted, i.e., illumination signal 400 of light pulse, and then captured, i.e., reflection illumination signal 401 of the light pulse. Due to the iToF camera being in “active” state at the time when its reflected pulse, i.e., the reflection illumination signal 401, of the light pulse is detected by the sensor, the corresponding generated photo-electrons will be collected. The “inactive” time of the iToF camera covers the time during which the overflow gate OFG is active. During the iToF camera's “inactive” time in which the overflow gate OFG is activated, draining all incoming photo-electrons is performed. In the embodiment depicted above, photo-electrons generated by the reflected pulse of the secondary iToF camera, i.e. reflected illumination signal 402, are drained by the overflow gate OFG and do not affect the measurement of the (primary) iToF camera.

In the embodiment of FIG. 4, multi-camera interference does not occur due to the reflected signal 402 of a secondary camera (see 109 in FIG. 1) falling in the “inactive” time of the primary camera (see 108 in FIG. 1). However, very often in a multi-camera scenario, multi-camera interference occurs due to the reflected signal 402 of a secondary camera falling in the “inactive” time of the primary camera. For example, multi-camera interference may occur if the secondary camera has an arbitrary offset comparing to the primary camera.

### Multi-Camera Interference

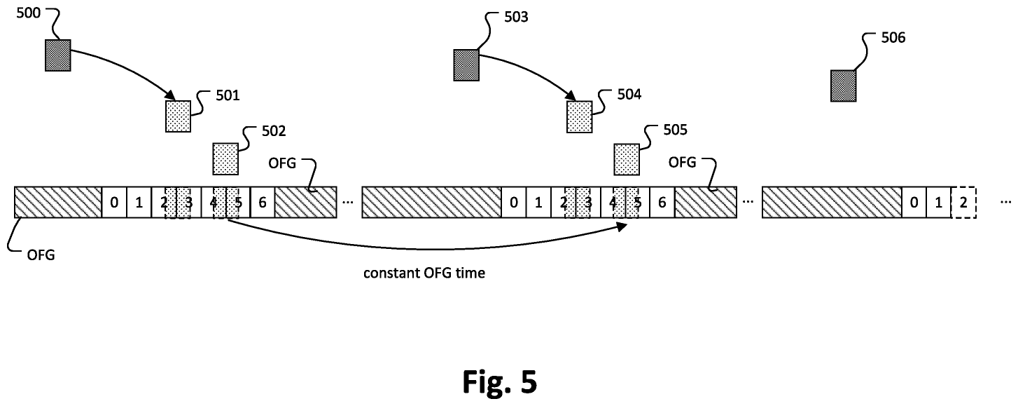

FIG. 5 schematically shows a timing diagram for a sub-integration cycle of an iToF pixel with seven taps (N=7 taps) in a multi-camera scenario, wherein the overflow gate OFG time is constant. Here, an embodiment of multi-camera interference occurring in a multi-camera scenario, wherein the overflow gate OFG time is constant, is described.

A (primary) light pulse 500 is emitted onto a scene (see 107 in FIG. 1) by a primary camera (see 108 in FIG. 1) in a multi-camera scenario. The reflected light pulse of the light pulse 500 reflected from the scene is received by the image sensor (see 102 in FIG. 2) of the primary camera as a usable range object reflection 501. A secondary light pulse (not shown) is emitted onto the scene from a secondary camera (see 109 in FIG. 1). The reflected light of the secondary light pulse is received by the image sensor of the primary camera as a reflection 502. The photo-electrons generated by the usable range object reflection 501 are captured by the third and the fourth tap, tap2 and tap3 respectively. The photo-electrons generated by the reflection 502 caused by the secondary camera are captured by the fifth and the sixth tap, tap4 and tap5 respectively. The overflow gate OFG is activated for a predetermined time (see t_{OFG} in FIG. 3) during the sub-integration cycle (see t_{sub} in FIG. 3), which is constant during the integration cycle. When the overflow gate OFG time t_{OFG} ends, a next light pulse 503 is emitted onto the scene by the primary camera, and a light pulse (not shown) is emitted onto the scene by the secondary camera. The photo-electrons generated by the usable range object reflection 504 are captured by the third and the fourth tap, tap2 and tap3 respectively. The photoelectrons generated by the reflection 505 caused by the secondary camera are captured by the fifth and the sixth tap, tap4 and tap5 respectively. The overflow gate OFG is activated for the predetermined and constant time (see t_{OFG} in FIG. 3) during the integration cycle. The same taps as described above, namely tap2 and tap3 capture the reflected light of a next light pulse 506 of the primary camera and tap4 and tap5 capture the reflected light of a light pulse 506 emitted by the secondary camera (not shown).

In the embodiment of FIG. 5, for the 7-tap case, the overflow gate OFG time (see t_{OFG} in FIG. 3) is kept constant and therefore the second camera's reflected light 502 and 505, i.e., interference signal, is captured by the same two taps, here tap4 and tap5, in each sub-integration time. This means that the interference signal will have a higher impact on the depth reconstruction. Since the N-tap Datapath, here 7-tap Datapath, generally relies on recognizing active signal by identifying “peaks”, i.e., high-value sum of two consecutive taps, the interference signal acts as an additional source of noise, other than ambient light.

It should be noted that even after the application of background suppression techniques, the residual in the “interference” taps may be significantly higher than in the ambient light-only, i.e., “empty” taps. The taps which do not collect any charges generated by the emitted light pulse (so called active light) but only ambient light are called “empty” taps. The taps containing charges generated by the emitted light pulse) are called “non-empty” taps. Taps may be classified as empty taps by determining which of the taps do provide a corresponding measurement which is below a predetermined threshold. Alternatively, empty taps may be identified if no peak is observed in the number of detected photons as compared to all tap information.

### Addressing Multi-Camera Interference

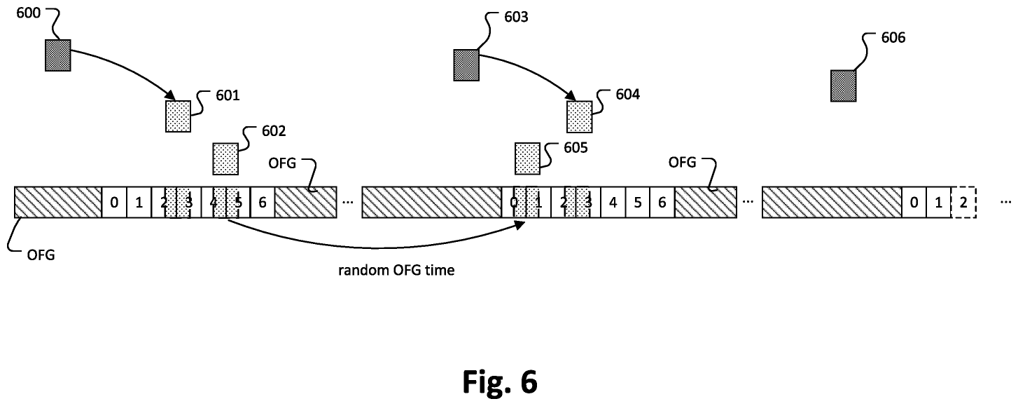

FIG. 6 schematically shows a timing diagram for a sub-integration cycle of an iToF pixel with seven taps in a multi-camera scenario, wherein the overflow gate OFG time is random. Here, an embodiment of addressing a multi-camera interference occurring in a multi-camera scenario, wherein the overflow gate OFG time is random, is described.

A light pulse 600 is emitted onto a scene (see 107 in FIG. 1) from a primary camera, in a multi-camera scenario. The reflected light pulse of the light pulse 600 reflected from the scene is received by the image sensor (see 102 in FIG. 2) of the primary camera (see 108 in FIG. 1) as a usable range object reflection 601. A light pulse (not shown) is emitted onto the scene by a secondary camera. The reflected light of the light pulse of the secondary camera is also received by the image sensor of the primary camera as a reflection 602 caused by another camera. The photo-electrons generated by the usable range object reflection 601 are captured by the third and the fourth tap, tap2 and tap3 respectively. The photo-electrons generated by the reflection 602 caused by the secondary camera are captured by the fifth and the sixth tap, tap4 and tap5 respectively. The overflow gate OFG is activated for a specific time (see t_{OFG} in FIG. 3) during the sub-integration cycle (see t_{sub} in FIG. 3), which is random during the integration cycle, e.g. pseudo-random time. When the overflow gate OFG time ends, another light pulse, here the light pulse 603 is emitted onto the scene by the primary camera, and a light pulse (not shown) is emitted onto the scene by the secondary camera. The photo-electrons generated by the usable range object reflection 604 are captured by the third and the fourth tap, tap2 and tap3 respectively. The photo-electrons generated by the reflection 605 caused by the secondary camera are captured by the first and the second tap, tap0 and tap1 respectively. The overflow gate OFG is activated for a specific time (see t_{OFG} in FIG. 3) during the integration cycle. The time during which the overflow gate OFG is activated is random and is different in every sub-integration cycle of the integration cycle. The same taps as described above, namely tap2 and tap3 capture the reflected light of a light pulse 606 of the primary camera and different taps than the taps described above, e.g., tap5 and tap6, capture the reflected light of a light pulse 606 emitted by the secondary camera (not shown).

In this manner, by activating the overflow gate OFG for non-constant time, the reflection caused by the illumination signal of a different camera may impact different taps in each sub-integration time. That means that by applying a random variation of the overflow gate OFG time (see t_{OFG} in FIG. 3), the interference signal is spread over different taps and the impact of another camera's interference may be significantly reduced.

In the embodiment of FIG. 6, a non-constant length of the overflow gate OFG time is set by applying a random variation of the overflow gate OFG time, without limiting the present embodiment in that regard. Alternatively, a deterministic variation may be applied instead of a random variation of the overflow gate time. For example, the overflow gate time within each sub-integration cycle may be slightly increased for a predetermined amount with each subsequent sub-integration cycle of the integration cycle. The overflow gate time may be increased e.g., 10 times (i.e., with 10 subsequent sub-integration cycles) and then return to the initiate amount and repeat the process. Still alternatively, a deterministic variation may be to set, for sub-integration cycles within an integration cycle, the length of the overflow gate time by choosing, for each subsequent sub-integration cycle, a different overflow gate time from a predefined overflow gate time list of randomly chosen overflow gate times stored in a memory.

It should be noted that in a multi-camera scenario, wherein two fully synchronous cameras illuminate the same scene, the interference signal may be reduced proportionally to the illumination signal's duty cycle (×50 in case of 1% duty cycle). Since the sub-integration time (see t_{sub} in FIG. 3) is intact, i.e., the time during which the taps are activated, there is no impact on the useful signal. That is, the “active” time remains the same, only the “dead” time changes in length.

It should be further noted that the average integration time is predictable and known, since it is related to a predefined number of light pulses being emitted onto a scene. By applying a random variation of the overflow fate OFG time, each frame length may be varying and may be different from each other during the signal. The difference between each frame length may be less than 0.1% of a frame length, and consequently, the signal and the light pulses are not affected.

### Electronic Device and System Implementation

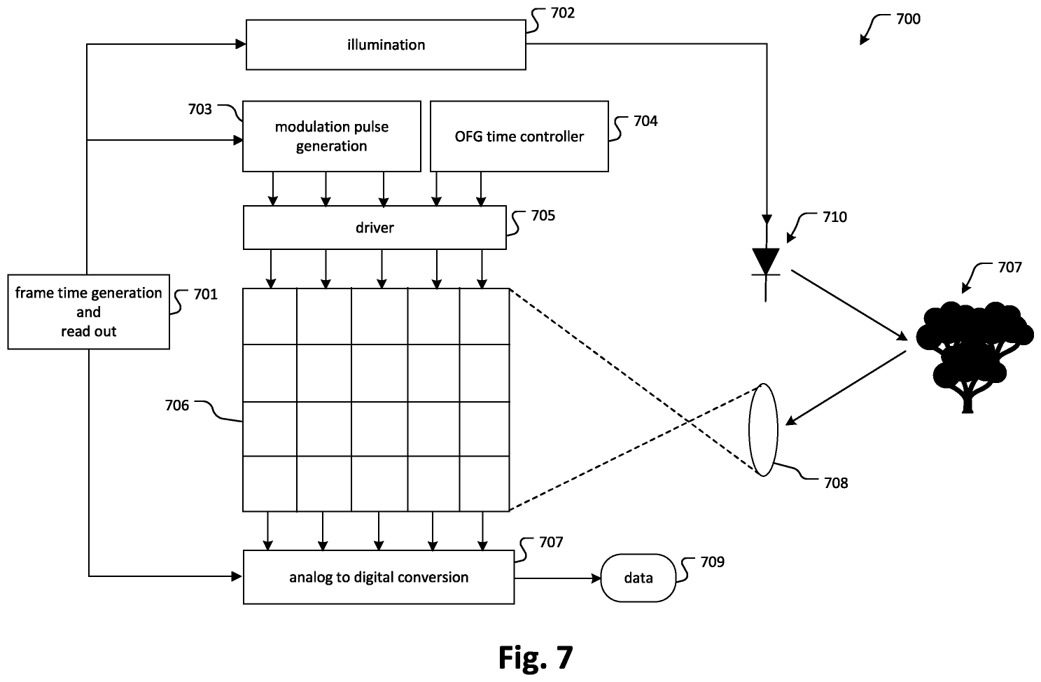

FIG. 7 schematically shows an embodiment of an electronic system including an electronic device that reduces multi-camera interference occurrence in a multi-camera scenario. The electronic system 700 comprises an electronic device, which is implemented for example as the iToF camera described with regard to FIGS. 1 and 2.

A frame time generation and read out 701 is performed to obtain a signal for generating a new frame. The obtained signal activates an illumination 702 and a modulation pulse generation 703. Illumination 702 is performed to generate an illumination sequence, i.e., sequence of light pulses, and to illuminate through an active source 710 a scene 707, as also described with regard to FIG. 2. Modulation pulse generation 703 is performed based on the obtained signal to generate a modulation signal which corresponds to the light pulses generated by the illumination 702, and to determine the starting time of the overflow gate, OFG, time (see FIG. 3). An OFG time controller 704 determines the length of the “inactive” time, (see OFG time t_{OFG} in FIG. 3). The length of the “inactive” time is random, e.g. pseudo-random, and is determined by performing Pseudo-Random Binary Sequence (PRBS) generation. Based on a feedback provided by the OFG time controller 704 to the modulation pulse generation 703, synchronization of the illumination pulses and the modulation signals is achieved. A lens 708 collects light reflected by objects within the scene 707 when illuminated by the active source 710 and forms an image of the objects within the scene 707 onto an imaging sensor 706. Based on the generated the modulation signal and the determined starting time and length of the overflow gate OFG time, a driver 705 controls the imaging sensor 706 such that the N-tap pixels to collect photo-electrons generated due to received light and to form an image of the objects within the scene 707. Once the photo-electron collection stage has ended, read out is performed by the frame time generation and read out 701 to obtain a readout sequence. An analog to digital conversion 707 is performed on the readout sequence to obtain readout data 709 based on a trigger signal generated by the frame time generation and read out 701. The readout data 709 are digital numbers which are then passed through the datapath.

The Pseudo-Random Binary Sequence (PRBS), which is a binary sequence, is generated with a deterministic algorithm. The PRBS is difficult to predict and shows statistical behaviour similar to a truly random sequence.

In the embodiment of FIG. 7, Pseudo-Random Binary Sequence (PRBS) generation is performed to determine the length of the “inactive” time, without limiting the present embodiment in that regard. Alternatively, variable-length codes respecting the prefix condition may be used to set the length of the OFG time, i.e., the “inactive” time. This may improve the detectability of the method, above that brought by a non-uniform OFG time.

It should be noted that different-length codes may be used for the OFG time of different cameras, helping to identify the different origin of the interference signal. For a given distance, the time between two active pulses in two consecutive “active” times is equal to an N-length code (OFG time for the primary camera) plus the “active” time minus one pulse width (the width of the reflected pulse is removed). Moreover, an additional active pulse is detected in each “active” time. Consider that the time between two of the additional active pulses in two consecutive “active” times is an M-length code plus the active time minus one pulse width, with M different from N. In this manner, it may be easy to conclude that the additional pulses correspond to an interference signal.

### Method

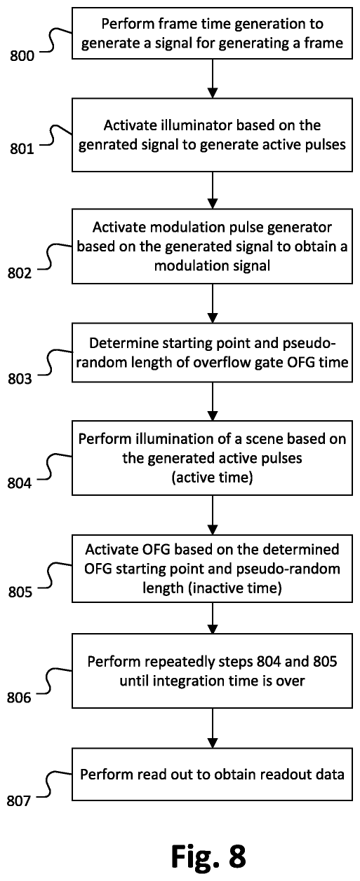

FIG. 8 shows a flow diagram visualizing a method for a multi-camera operation in an N-tap system for reducing multi-camera interference. The multi-camera operation is performed in a multi-camera scenario, wherein the operated cameras are two iToF cameras, one is a primary camera and the other is a secondary camera.

At 800, frame time generation is performed to generate a signal for generating a frame. At 801, an illuminator of an iToF camera, e.g., of the primary camera, is activated to generate active pulses to illuminate a scene (see FIGS. 1, 2, and 7). At 802, a modulation pulse generator is based on the generated signal to obtain a modulation signal. At 803, a starting point and a pseudo-random length of the overflow gate OFG time is set. The pseudo-random length is set, for example, based on Pseudo-Random Binary Sequence (PRBS) generation (see FIG. 7). At 804, illumination of the scene is performed based on the generated active pulses (“active” time). The active pulses are reflected from objects within the illuminated scene and the reflected light is captured by the iToF camera based on photo-electron collection by N transfer gates corresponding to respective N-taps. At 805, overflow gate OFG activation is performed based on the determined overflow gate OFG starting point and the pseudo-random length (“inactive” time). At 806, the steps 804 and 805 are performed repeatedly until integration time is over. At 807, read out is performed to obtain readout data (see FIG. 7).

In the embodiment of FIG. 8, the multi-camera operation is performed by iToF cameras, without limiting the present embodiment in that regard. Alternatively, dToF cameras may be used. Here, the iToF cameras include N-tap pixels. The number of taps may be any number larger than 3 (N>3), without limiting the present embodiment in that regard. Alternatively, the number of taps may be equal to or larger than 2 (N≥2).

It should be noted that the above described method of FIG. 8 may be performed by any electronic device, such as a camera, that uses an N-type technology or any technology wherein “inactive” time is used.

It should be noted that the methods as described herein are also implemented in some embodiments as a computer program causing a computer and/or a processor and/or circuitry to perform the method, when being carried out on the computer and/or processor and/or circuitry. In some embodiments, also a non-transitory computer-readable recording medium is provided that stores therein a computer program product, which, when executed by a processor, such as the processor described above, causes the methods described herein to be performed.

It should be recognized that the embodiments describe methods with an exemplary ordering of method steps. The specific ordering of method steps is, however, given for illustrative purposes only and should not be construed as binding.

It should also be noted that the division of the electronic device of FIG. 7 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

Note that the present technology can also be configured as described below.

(1) An electronic device comprising circuitry configured to randomly set, for sub-integration cycles (t_{sub}) within an integration cycle (tᵢₙₜ) of a pixel of a time-of-flight imaging sensor, a non-constant length of an overflow gate time (t_{OFG}) during which an overflow gate (OFG) of the pixel is active.

(2) The electronic device of (1), wherein the circuitry is configured to randomly set for a sub-integration cycle (t_{sub}) within the integration cycle (tᵢₙₜ) the length of the overflow gate time (t_{OFG}).

(3) The electronic device of (1), wherein the circuitry is configured to activate the overflow gate (OFG) within the sub-integration cycle (t_{sub}).

(4) The electronic device of (3), wherein the circuitry is configured to activate transfer gates of the pixel within the sub-integration cycle (t_{sub}) one after the other for a predetermined time (tₘₐₓ) according to a predetermined pulse width equal to a pulse width (tₚ) of a light pulse (302) of a light pulse sequence (301) produced by an illumination unit of the time-of-flight imaging sensor.

(5) The electronic device of (4), wherein the circuitry is configured to activate the overflow gate (OFG) after the end of the predetermined time (tₘₐₓ) within which the transfer gates have been activated.

(6) The electronic device of (4), wherein the sub-integration cycle (t_{sub}) is defined by each pulse (302) of the light pulse sequence (301) produced by the illumination unit of the time-of-flight imaging sensor.

(7) The electronic device of (4), wherein the integration cycle (tᵢₙₜ) comprises a plurality of sub-integration cycles (t_{sub}) and is defined by the light pulse sequence (301) produced by the illumination unit of the time-of-flight imaging sensor.

(8) The electronic device of (7), wherein reflected light of each pulse (302) of the light pulse sequence (301) is captured by the transfer gates based on photo-electron collection within the sub-integration cycle (t_{sub}).

(9) The electronic device of (8), wherein, in at least two sub-integration cycles (t_{sub}) within the integration cycle (tᵢₙₜ), the reflected light of each pulse (302) is capture by different transfer gates of the pixel.

(10) The electronic device of (3), wherein the circuitry is configured to set a starting point of the overflow gate time (t_{OFG}) in which the overflow gate (OFG) is activated within the sub-integration cycle (t_{sub}).

(11) The electronic device of (7), wherein each of plurality of sub-integration cycles (t_{sub}) within the integration cycle (tᵢₙₜ) is constant.

(12) The electronic device of anyone of (1) to (11), wherein the length of the overflow gate time (t_{OFG}) is set by applying a random variation on the overflow gate time (t_{OFG}).

(13) The electronic device of anyone of (1) to (12), wherein the length of the overflow gate time (t_{OFG}) is randomly set based on a binary sequence.

(14) The electronic device of (13), wherein the binary sequence is a pseudorandom binary sequence (PRBS).

(15) The electronic device of anyone of (1) to (14), wherein the length of the overflow gate time (t_{OFG}) is randomly set based on a variable-length code.

(16) The electronic device of anyone of (1) to (15), wherein the length of the overflow gate time (t_{OFG}) is randomly set based on a different-length code.

(17) The electronic device of anyone of (1) to (16), wherein the time-of-flight imaging sensor is part of a primary time-of-flight camera (108) in a multicamera (108, 109) scenario.

(18) The electronic device of (17), wherein the multicamera (108, 109) scenario comprises at least one secondary time-of-flight camera (109).

(19) The electronic device of (18), wherein the primary time-of-flight camera (108) and the secondary time-of-flight camera (109) are of the iToF type or dtoF type.

(20) A method comprising setting, for sub-integration cycles (t_{sub}) within an integration cycle (tᵢₙₜ) of a pixel of a time-of-flight imaging sensor, a non-constant length of an overflow gate time (t_{OFG}) during which an overflow gate (OFG) of the pixel is active.

(21) A computer program comprising instructions which, when the program is executed by a computer, cause the computer to carry out the method of (20).

1. An electronic device comprising circuitry configured to set, for sub-integration cycles within an integration cycle of a pixel of a time-of-flight imaging sensor, a non-constant length of an overflow gate time during which an overflow gate of the pixel is active.

2. The electronic device of claim 1, wherein the circuitry is configured to randomly set for a sub-integration cycle within the integration cycle the length of the overflow gate time.

3. The electronic device of claim 1, wherein the circuitry is configured to activate the overflow gate within the sub-integration cycle.

4. The electronic device of claim 3, wherein the circuitry is configured to activate transfer gates of the pixel within the sub-integration cycle one after the other for a predetermined time according to a predetermined pulse width equal to a pulse width of a light pulse of a light pulse sequence produced by an illumination unit of the time-of-flight imaging sensor.

5. The electronic device of claim 4, wherein the circuitry is configured to activate the overflow gate after the end of the predetermined time within which the transfer gates have been activated.

6. The electronic device of claim 4, wherein the sub-integration cycle is defined by each pulse of the light pulse sequence produced by the illumination unit of the time-of-flight imaging sensor.

7. The electronic device of claim 4, wherein the integration cycle comprises a plurality of sub-integration cycles and is defined by the light pulse sequence produced by the illumination unit of the time-of-flight imaging sensor.

8. The electronic device of claim 7, wherein reflected light of each pulse of the light pulse sequence is captured by the transfer gates based on photo-electron collection within the sub-integration cycle.

9. The electronic device of claim 8, wherein, in at least two sub-integration cycles within the integration cycle, the reflected light of each pulse is capture by different transfer gates of the pixel.

10. The electronic device of claim 3, wherein the circuitry is configured to set a starting point of the overflow gate time in which the overflow gate is activated within the sub-integration cycle.

11. The electronic device of claim 6, wherein each of plurality of sub-integration cycles within the integration cycle is constant.

12. The electronic device of claim 1, wherein the length of the overflow gate time is set by applying a random variation on the overflow gate time.

13. The electronic device of claim 1, wherein the length of the overflow gate time is randomly set based on a binary sequence.

14. The electronic device of claim 13, wherein the binary sequence is a pseudorandom binary sequence.

15. The electronic device of claim 1, wherein the length of the overflow gate time is randomly set based on a variable-length code.

16. The electronic device of claim 1, wherein the length of the overflow gate time is randomly set based on a different-length code.

17. The electronic device of claim 1, wherein the time-of-flight imaging sensor is part of a primary time-of-flight camera in a multicamera scenario.

18. The electronic device of claim 17, wherein the multicamera scenario comprises at least one secondary time-of-flight camera.

19. The electronic device of claim 18, wherein the primary time-of-flight camera and the secondary time-of-flight camera are of the iToF type or dtoF type.

20. A method comprising setting, for sub-integration cycles within an integration cycle of a pixel of a time-of-flight imaging sensor, a non-constant length of an overflow gate time during which an overflow gate of the pixel is active.

21. A computer program comprising instructions which, when the program is executed by a computer, cause the computer to carry out the method of claim 20.
